(19) United States
(12) Patent Application Publication
(10) Pub. No.: US 2025/0100814 A1
(43) Pub. Date: Mar. 27, 2025

(54) CONTROL DEVICE, HOLDING SYSTEM, CARGO HANDLING DEVICE, PROCESSING METHOD, AND STORAGE MEDIUM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Takafumi USHIYAMA, Sagamihara (JP); Atsushi SUGAHARA, Kawasaki (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 18/604,362

(22) Filed: Mar. 13, 2024

(30) Foreign Application Priority Data
Sep. 22, 2023 (JP) 2023-158092

(51) Int. Cl. B65G 47/91

(52) U.S. Cl. CPC B65G 47/917; B65G 47/912

(57) ABSTRACT

According to one embodiment, a control device controls a holding device capable of holding an object. The control device calculates a first position at which a first object is held by the holding device. The control device determines whether the holding device is capable of coming into contact with another object when the holding device is present at the first position. In a case where the holding device is capable of coming into contact with the other object, the control device calculates a second position at which the holding device comes into contact with the first object and does not come into contact with the other object.

### CROSS-REFERENCE TO RELATED APPLICATIONS

This application is based upon and claims the benefit of priority from Japanese Patent Application No. 2023-158092, filed on Sep. 22, 2023; the entire contents of which are incorporated herein by reference.

### FIELD

Embodiments described herein relate generally to a control device, a holding system, a cargo handling device, a processing method, and a storage medium.

### BACKGROUND

There is a holding device capable of holding an object. A technique capable of causing the holding device to hold only a target object is required.

### BRIEF DESCRIPTION OF THE DRAWINGS

FIG. 1 is a schematic view showing a configuration of a holding system according to an embodiment;

FIG. 2 is a schematic view showing an operation of the holding system according to the embodiment;

FIGS. 3A to 3C are schematic views showing a method of calculating the first position;

FIG. 4 is a flowchart showing the method of calculating the first position;

FIGS. 5A and 5B are schematic views showing a method of contact determination and a method of calculating the second position;

FIGS. 6A to 6C are schematic views showing the method of the contact determination and the method of calculating the second position;

FIGS. 7A and 7B are schematic views showing the method of the contact determination and the method of calculating the second position;

FIG. 8 is a flowchart showing an operation of the holding system according to the embodiment;

FIG. 9 is a schematic side view showing a holding device according to the embodiment;

FIGS. 10A to 10D are schematic views showing an operation of the holding system according to the embodiment;

FIGS. 11A to 11C are schematic views showing the operation of the holding system according to the embodiment;

FIGS. 12A to 12D are schematic views showing the operation of the holding system according to the embodiment;

FIG. 13 is a schematic view showing a configuration of a holding system according to a first variation of the embodiment;

FIG. 14 is a perspective view schematically showing a cargo handling device according to an example;

FIGS. 15A to 15C are schematic views showing an operation of the cargo handling device according to the embodiment;

FIGS. 16A and 16B are schematic views showing the operation of the cargo handling device according to the embodiment;

FIGS. 17A and 17B are schematic views showing the operation of the cargo handling device according to the embodiment;

FIGS. 18A to 18C are schematic views showing another operation performed by the cargo handling device according to the embodiment;

FIGS. 19A to 19C are schematic views showing the other operation performed by the cargo handling device according to the embodiment;

FIGS. 20A and 20B are schematic views illustrating an arrangement of a suction pads 11; and

FIG. 21 is a schematic view showing a hardware configuration.

### DETAILED DESCRIPTION

According to one embodiment, a control device controls a holding device capable of holding an object. The control device calculates a first position at which a first object is held by the holding device. When the holding device is present at the first position, the control device determines whether the holding device is capable of coming into contact with another object. When the holding device is capable of coming into contact with the other object, the control device calculates a second position at which the holding device comes into contact with the first object and does not come into contact with the other object.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

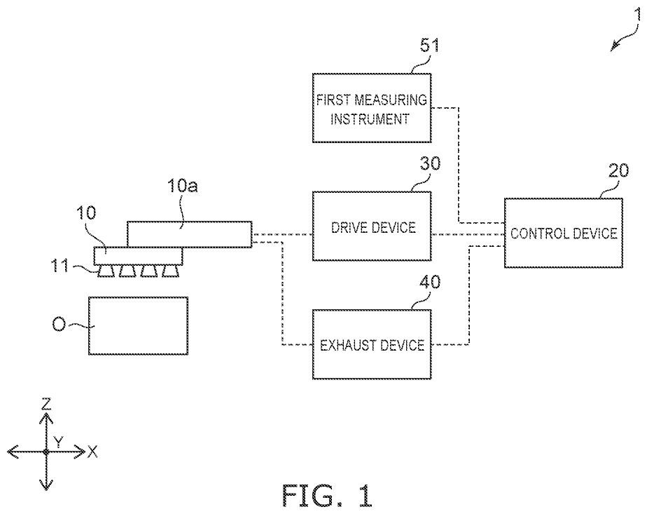

FIG. 1 is a schematic view showing a configuration of a holding system according to an embodiment.

A holding system 1 according to the embodiment includes a holding device 10, a control device 20, a drive device 30, an exhaust device 40, and a first measuring instrument 51.

The holding device 10 can hold an object O. In a shown example, the holding device 10 includes multiple suction pads 11. The object O is held when one or more suction pads 11 are suctioned to a surface of the object O. The holding device 10 is fixed to an arm 10a.

The holding device 10 may include a jamming mechanism instead of the suction pads 11. The jamming mechanism includes a flexible bag and powdery and granular material provided in the bag. After the bag comes into contact with the object O and the bag and the powdery and granular material deform along a shape of the object O, the inside of the bag is exhausted. When the bag is deflated due to exhaustion, the powdery and granular material is solidified. In a state in which the bag is in close contact with the object O, the object O is held by fixing a shape of the powdery and granular material.

The control device 20 controls the holding device 10. Specifically, the control device 20 controls an operation of the holding device 10 by operating the drive device 30 and the exhaust device 40. The drive device 30 includes an actuator and moves the arm 10a. The control device 20 operates the drive device 30 to control a position of the holding device 10. The exhaust device 40 is connected to the suction pad 11 of the holding device 10 and exhausts the inside of the suction pad 11. When pressure inside the suction pad 11 is less than atmospheric pressure, a suction force is generated on the suction pad 11. In a case where the holding device 10 includes the jamming mechanism, the inside of the bag of the holding device 10 is exhausted by the exhaust device 40. The control device 20 operates the exhaust device 40 to switch between a state in which the holding device 10 holds the object O and a state in which the holding device 10 does not hold the object O.

The first measuring instrument 51 measures the object O from a first direction, and acquires a position and a size of the object O on a first surface intersecting the first direction. The first measuring instrument 51 transmits a first measurement result including the position and size of the object O to the control device 20. For example, the first measuring instrument 51 includes a camera that acquires an image and a processing device that processes the image. The processing device measures the position and size of the object O from an acquired two-dimensional image. The control device 20 may function as the processing device. The camera may be capable of acquiring depth information (distance in the first direction) in addition to the two-dimensional image.

Alternatively, the first measuring instrument 51 may include a distance measuring sensor and the processing device. The distance measuring sensor emits light and receives reflected light. The processing device measures the position and size of the object O from the received reflected light. In a case where the distance measuring sensor is used, the distance measuring sensor is favorably a laser range finder (LRF) from a viewpoint of accuracy.

The control device 20 calculates a first position at which the holding device 10 holds the object O using the first measurement result received from the first measuring instrument 51. Further, the control device 20 determines whether the holding device 10 can come into contact with another object when the holding device 10 is present at the first position. In a case where it is determined that the holding device 10 does not come into contact with the other object at the first position, the control device 20 determines whether the first position is within a movable range of the holding device 10. In the case where the first position is within the movable range of the holding device 10, the control device 20 determines a position when the holding device 10 holds the object O as the first position. The control device 20 moves the holding device 10 to the first position and causes the holding device 10 to hold the object O at the first position.

In the case where the holding device 10 can come into contact with the other object at the first position, the control device 20 calculates a second position at which the holding device 10 holds the object O. The second position is different from the first position. At the second position, the holding device 10 is only in contact with the object O which is a holding target, and is not in contact with the other object. Therefore, even when multiple objects are adjacent to each other, the holding device 10 can selectively hold only the object O. When the second position is calculated, the control device 20 determines whether the second position is within the movable range of the holding device 10. In the case where the second position is within the movable range of the holding device 10, the control device 20 determines a position when the holding device 10 holds the object O as the second position. The control device 20 moves the holding device 10 to the second position and causes the holding device 10 to hold the object at the second position.

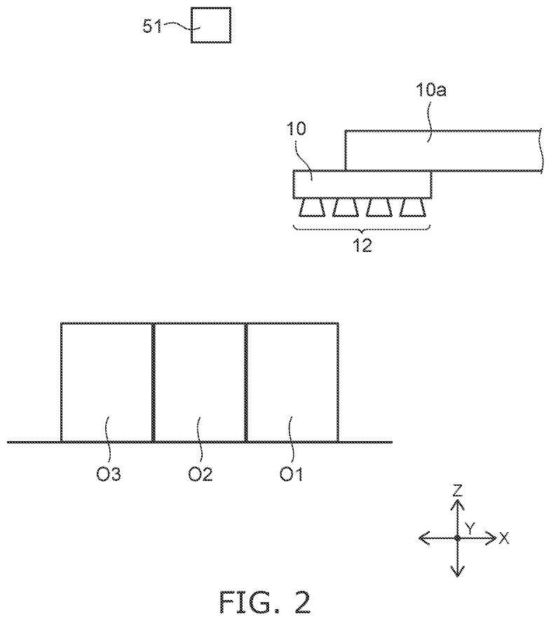

FIG. 2 is a schematic view showing an operation of the holding system according to the embodiment.

For example, as shown in FIG. 2, multiple objects O1 to O3 are arranged. The objects O1 to O3 are sequentially held and conveyed by the holding device 10. In the example, a size of a holding region 12 of the holding device 10 is larger than a size of a surface on which the objects O1 to O3 are held. The holding region 12 is a region in the holding device 10 in which an object can be held. In an example shown in FIG. 2, the holding region 12 includes suction surfaces of the multiple suction pads 11.

First, the first measuring instrument 51 measures a position and a size of each of the objects O1 to O3 from the first direction. Here, a direction in which the first measuring instrument 51 measures an object is defined as a Z-direction. A direction intersecting the Z-direction is defined as an X-direction (second direction). A direction intersecting a plane parallel to the X-direction and the Z-direction is defined as a Y-direction (third direction). For example, the Z-direction is parallel to a vertical direction. The X-direction and the Y-direction are parallel to a horizontal plane and are orthogonal to each other. An example in which the Z-direction is parallel to the vertical direction will be described. For the sake of description, a direction parallel to the Z-direction and from the first measuring instrument 51 toward the object is referred to as “downward”, and an opposite direction is referred to as “upward”.

The control device 20 acquires a position of each object in an X-Y plane, a dimension of each object in the X-direction, and a dimension of each object in the Y-direction from the first measuring instrument 51. The control device 20 selects an object to be held based on the positions and the dimensions. Selection criterion is freely set. For example, the control device 20 selects an object having a shortest distance from the first measuring instrument 51 in the Z-direction from the multiple objects. That is, the control device 20 selects an object whose upper surface is at a highest position. When there are multiple objects whose upper surface are each at the highest position, the control device 20 selects any one of the objects. For example, the control device 20 calculates a distance between a reference position in the X-Y plane and each object. The control device 20 selects an object having the shortest distance.

In the example shown in FIG. 2, positions of upper surfaces of the objects O1 to O3 in the Z-direction are the same. The control device 20 selects the object O1 (an example of a first object) closest to the holding device 10 in the X-Y plane as a holding target from the objects O1 to O3.

When the object to be held is selected, the control device 20 calculates the first position at which the object is held. For example, the control device 20 calculates, as the first position, a position at which a center of gravity of the holding device 10 in the X-Y plane coincides with a center of gravity of the object in the X-Y plane. When a position of the center of gravity of the holding device 10 in the X-Y plane coincides with a position of the center of gravity of the object in the X-Y plane, a moment applied to the holding device 10 when the holding device 10 holds and lifts the object can be minimized. That is, the object can be conveyed more stably. The control device 20 may calculate a position at which the most suction pads 11 come into contact with the object O1 as the first position. Accordingly, a holding force of the holding device 10 can be increased.

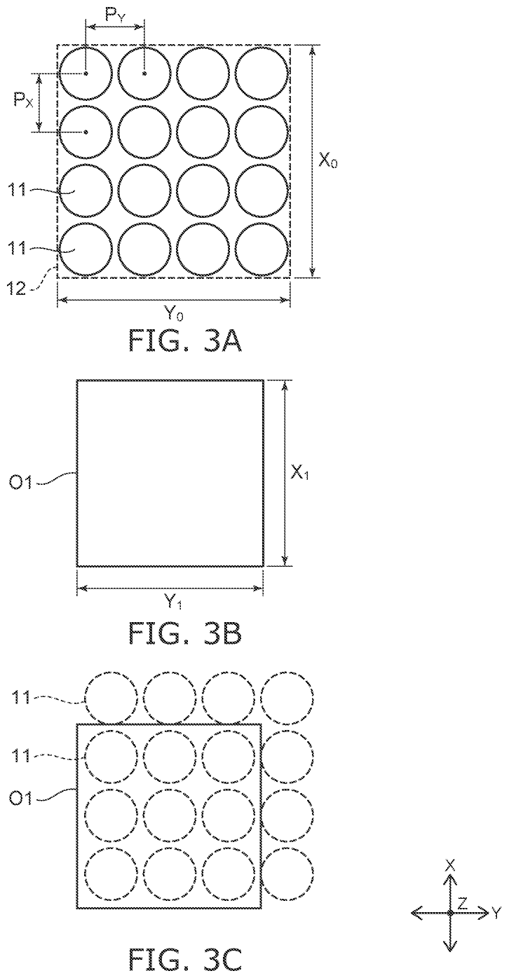

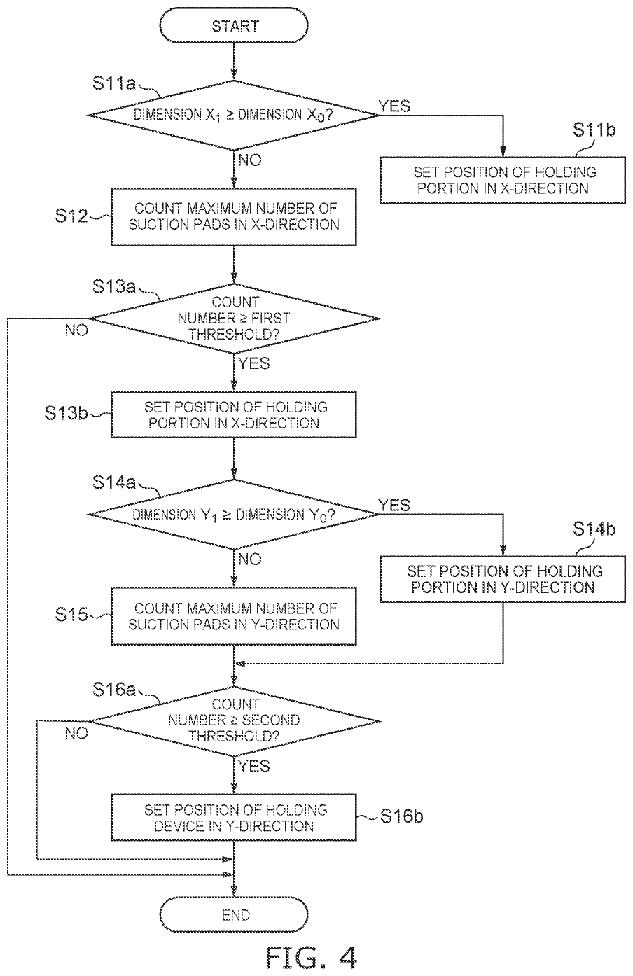

FIGS. 3A to 3C are schematic views showing a method of calculating the first position. FIG. 4 is a flowchart showing the method of calculating the first position.

FIG. 3A shows the holding device 10 when viewed from the Z-direction. A dimension X₀ indicates a length of the holding region 12 in the X-direction. A dimension Y₀ indicates a length of the holding region 12 in the Y-direction. FIG. 3B shows the object O1 when viewed from the Z-direction. A dimension X₁ indicates a length of the object O1 in the X-direction. A dimension Y₁ indicates a length of the object O1 in the Y-direction.

As shown in FIG. 4, first, the control device 20 determines whether the dimension X₁ is equal to or greater than the dimension X₀ (step S11a). If the dimension X₁ is equal to or greater than the dimension X₀, a position of a center of the object O1 in the X-direction is set as a position of a center of the holding device 10 (the multiple suction pads 11) in the X-direction (step S11b). Accordingly, a position of the holding device 10 in the X-direction is set.

If the dimension X₁ is smaller than the dimension X₀, the control device 20 refers to a pitch P_{X} (shown in FIG. 3) of the suction pads 11 in the X-direction and the dimension X₁. The pitch P_{X} corresponds to a distance between centers of the suction pads 11 in the X-direction, and is equal to the sum of a dimension of each suction pad 11 in the X-direction and a distance between adjacent suction pads 11 in the X-direction. The control device 20 counts a maximum number of the suction pads 11 that can be present in the X-direction in a range of the dimension X₁ (step S12).

The control device 20 determines whether the counted number is equal to or greater than a preset first threshold (step S13a). The first threshold is a minimum number of the suction pads 11 in the X-direction necessary for holding the object O1. In the case where the counted number is less than the first threshold, the control device 20 determines that the holding device 10 cannot hold the object O1, and ends the processing. In the case where the counted number is equal to or greater than the first threshold, the control device 20 specifies a suction pad 11 located at a center in the X-direction among the suction pads 11 that are in contact with the object O1. The control device 20 sets a position of a center of the specified suction pad 11 in the X-direction to the position of the center of the object O1 in the X-direction (step S13b). Accordingly, the position of the holding device 10 in the X-direction is set.

After the position of the holding device 10 in the X-direction is set, the control device 20 determines whether the dimension Y₁ is equal to or greater than the dimension Y₀ (step S14a). In the case where the dimension Y₁ is equal to or greater than the dimension Y₀, a position of a center of the object O1 in the Y-direction is set as a position of a center of the holding device 10 in the Y-direction (step S14b). Accordingly, a position of the holding device 10 in the Y-direction is set.

In the case where the dimension Y₁ is smaller than the dimension Y₀, the control device 20 refers to a pitch P_{Y} of the suction pads 11 in the Y-direction and the dimension Y₁. The pitch P_{Y} corresponds to a distance between centers of the suction pads 11 in the Y-direction, and is equal to the sum of a dimension of each suction pad 11 in the Y-direction and a distance between adjacent suction pads 11 in the Y-direction. The control device 20 counts a maximum number of suction pads 11 that can be present in the Y-direction in a region of the dimension Y₁ (step S15).

The control device 20 determines whether the counted number is equal to or greater than a preset second threshold (step S16a). The second threshold is a minimum number of the suction pads 11 in the Y-direction necessary for holding the object O1. In the case where the counted number is less than the second threshold, the control device 20 determines that the holding device 10 cannot hold the object O1, and ends the processing. In the case where the counted number is equal to or greater than the second threshold, the control device 20 specifies a suction pad 11 located at a center in the Y-direction among the suction pads 11 that are in contact with the object O1. The control device 20 determines a position of a center of the specified suction pad 11 in the Y-direction to the position of the center of the object O1 in the Y-direction (step S16b). Accordingly, the position of the holding device 10 in the Y-direction is set.

The first threshold and the second threshold may be collectively set for multiple articles or may be set for each article. For example, a database in which a size and a weight of each article are registered may be prepared in advance. The control device 20 accesses the database and refers to a weight of an article to be held. The control device 20 increases the first threshold and the second threshold as the weight increases.

In an example shown in FIG. 3A and FIG. 3B, the dimension X₁ is smaller than the dimension X₀. Therefore, the control device 20 counts the maximum number of the suction pads 11 that can be present in the X-direction in the dimension X₁. In the shown example, the dimension X₁ is greater than three times the pitch P_{X} and smaller than four times the pitch P_{X}. In a range of the dimension X₀, up to three suction pads 11 may be present in the X-direction. Therefore, the counted number is “three”. In the case where “three” is equal to or greater than the first threshold, the position of the suction pad 11 located at the center in the X-direction among the suction pads 11 that are in contact with the object O1 is set to the position of the center of the object O1 in the X-direction.

Thereafter, similarly to a method of setting the position in the X-direction, a position in the Y-direction is set. As a result, as shown in FIG. 3C, the positions of the multiple suction pads 11 for holding the object O1 are set. Through the above processing, the first position including the position of the holding device 10 in the X-direction and the position of the holding device 10 in the Y-direction is calculated.

After calculating the first position, the control device 20 determines whether the holding device 10 can come into contact with the other object when the holding device 10 is present at the first position. Hereinafter, the determination processing is also referred to as “contact determination”. For example, the size of the holding region 12 in the X-Y plane is registered in advance. The control device 20 determines whether the holding device 10 comes into contact with the other object using a measurement result of each object obtained by the first measuring instrument 51, the calculated first position, and the size of the holding region 12 registered in advance.

The control device 20 favorably determines whether the holding device 10 can come into contact with the other object by further using a measurement error. The measurement error includes a position error of the object, a size error of the object, and the like. The measurement error is preset in consideration of the error caused by the first measuring instrument 51. For example, the control device 20 adds a measurement error in the X-direction and a measurement error in the Y-direction to the size of the holding region 12. When a center of the holding region 12 is at the first position, in a case where the holding region 12 to which the measurement error is added comes into contact with the other object, the control device 20 determines that the holding device 10 can come into contact with the other object.

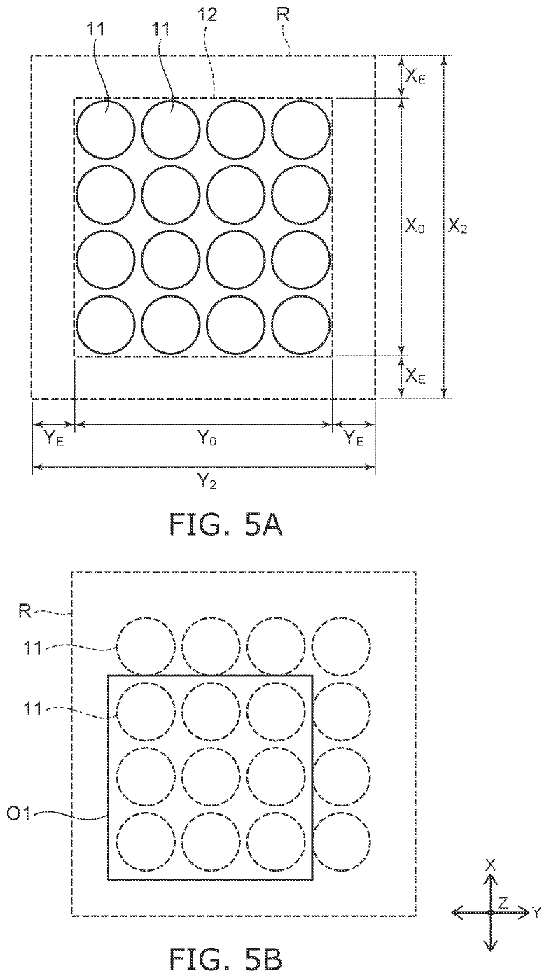

FIGS. 5A, 5B, 6A to 6C, 7A, and 7B are schematic views showing a method of the contact determination and a method of calculating the second position.

In FIG. 5A, a measurement error X_{E} indicates an error in the X-direction measured by the first measuring instrument 51. A measurement error Y_{E} indicates an error in the Y-direction measured by the first measuring instrument 51. The control device 20 calculates a dimension X₂ by adding the measurement error XE to the dimension X₀. The control device 20 calculates a dimension Y₂ by adding the measurement error Y_{E} to the dimension Y₀. Accordingly, a first region R including the dimension X₂ and the dimension Y₂ is calculated. In consideration of the measurement error, the first region R is a maximum region in which the holding region 12 may come into contact with the object.

The control device 20 executes processing of the flowchart shown in FIG. 4 using the dimension X₂ and the dimension Y₂. For example, in step S11a, it is determined whether the dimension X₁ is equal to or greater than the dimension X₂. In step S14a, it is determined whether the dimension Y₁ is equal to or greater than the dimension Y₂. As a result of the processing of the flowchart shown in FIG. 4, for example, as shown in FIG. 5B, the control device 20 calculates the first position of the holding device 10 for holding the object O1. The control device 20 determines whether the first region R having the dimension X₂ and the dimension Y₂ comes into contact with the other object when the holding device 10 is present at the first position.

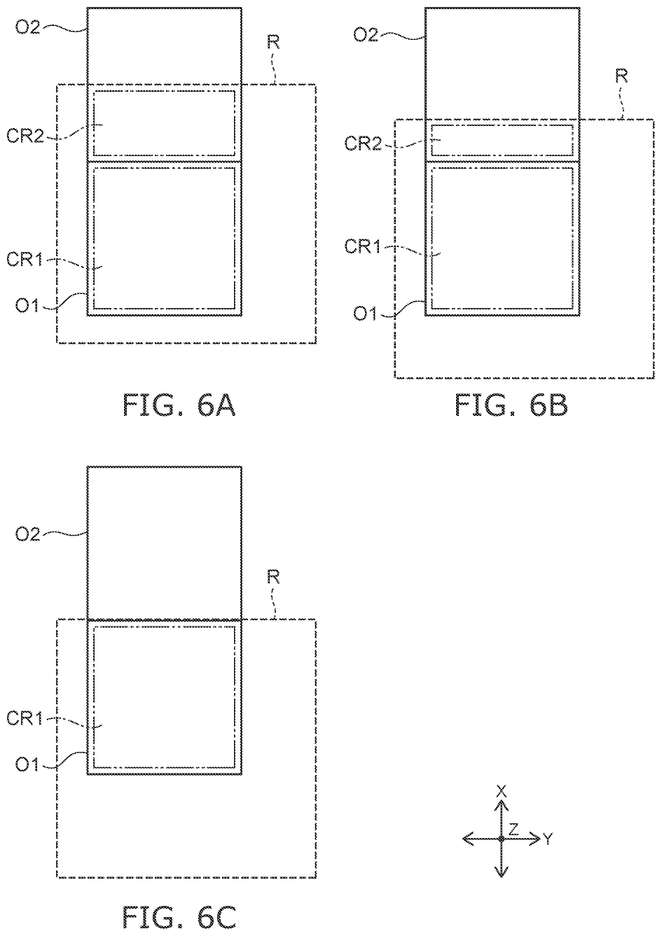

In an example shown in FIG. 5B, a size of the first region R is larger than a size of the object O1 in the X-Y plane. A part of the first region R protrudes from the object O1. As a result, when the holding device 10 is present at the first position, as shown in FIG. 6A, the holding device 10 is aligned with the object O2 in the Z-direction. The first region R and an upper surface of the object O2 are present at the same position in the Z-direction. Therefore, when the holding device 10 holds the object O1 at the first position, the object O2 may also be held. The control device 20 determines that the holding device 10 can come into contact with the other object other than the object O1 at the first position.

In this case, in order to calculate the second position, the control device 20 specifies a contact region CR1 in which the holding device 10 and the object O1 come into contact with each other and a contact region CR2 in which the holding device 10 and the object O2 come into contact with each other. The control device 20 changes the position of the holding device 10 from the first position toward the contact region CR1 from the contact region CR2. The control device 20 determines whether the holding device 10 can come into contact with the other object other than the object O1 at a changed position. In the case where the holding device 10 can come into contact with the other object, the control device 20 further changes the position of the holding device 10. Every time the position is changed, the control device 20 determines whether the holding device 10 can come into contact with the other object. By alternately repeating the position change and the contact determination, a position at which the holding device 10 comes into contact with only a target object is searched for.

FIG. 6B shows a situation when the position of the holding device 10 is changed from a state shown in FIG. 6A. FIG. 6C shows a situation when the position of the holding device 10 is further changed from the state shown in FIG. 6B. By changing the position of the holding device 10 from the contact region CR2 toward the contact region CR1, the contact region CR2 becomes smaller. As a result, as shown in FIG. 6C, the position of the holding device 10 at which the contact region CR2 is not present is obtained. The control device 20 calculates the position shown in FIG. 6C as the second position. When the holding device 10 holds the object O1 at the second position, the holding device 10 does not hold the object O2. Accordingly, only the target object O1 can be selectively held and conveyed.

In the case where the second position is calculated, the control device 20 may determine whether the holding device 10 can hold the target object at the second position. For example, the control device 20 specifies the suction pads 11 that are in contact with the object O1 at the second position shown in FIG. 6C. The control device 20 compares a maximum number of the suction pads 11 in the X-direction among the specified suction pads 11 with the first threshold. The control device 20 compares a maximum number of the suction pads 11 in the Y-direction among the specified suction pads 11 with the second threshold. When the maximum number in the X-direction is equal to or greater than the first threshold and the maximum number in the Y-direction is equal to or greater than the second threshold, the control device 20 determines that the holding device 10 can hold the object O1 at the second position.

In the case where it is determined that the object O1 cannot be held by the holding device 10 at the second position, the control device 20 selects another second object as a conveying target. Thereafter, as in the example described above, the first position at which the second object is held is calculated. In the case where the holding device 10 can come into contact with another object other than the second object at the first position, the second position is calculated.

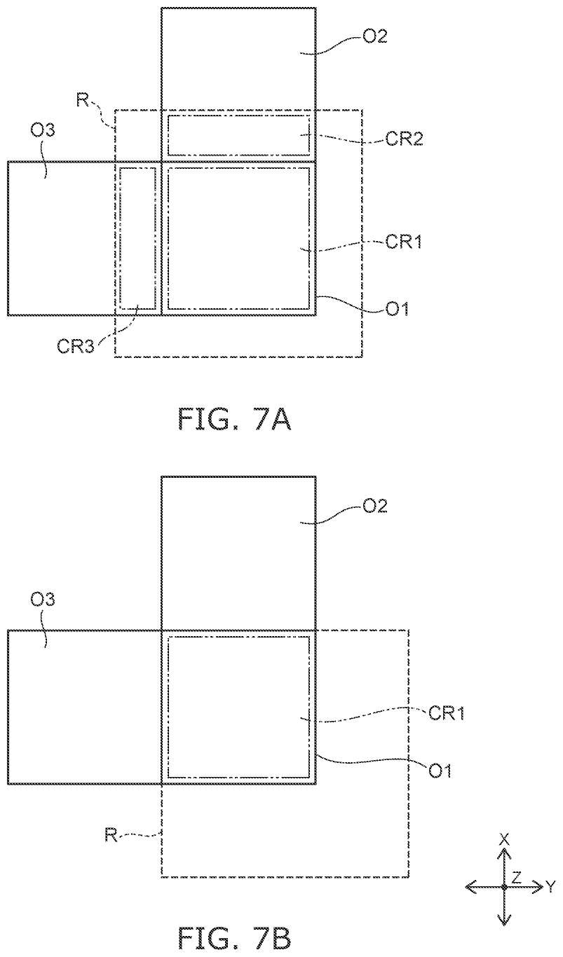

In the example shown in FIGS. 2 and 6A to 6C, the multiple objects are arranged in one direction (X-direction). When the multiple objects are arranged in two directions, the first position and the second position are also calculated as in the example described above. For example, as shown in FIG. 7A, the object O1 and the object O2 are arranged in the X-direction, and the object O1 and the object O3 are arranged in the Y-direction. The first region R comes into contact with the objects O2 and O3 in addition to the object O1. Therefore, there are the contact region CR2 between the first region R and the object O2 and a contact region CR3 between the first region R and the object O3. The control device 20 changes the position of the holding device 10 from the first position in a direction from the contact region CR2 toward the contact region CR1 and in a direction from the contact region CR3 toward the contact region CR1. Accordingly, as shown in FIG. 7B, the second position at which the first region R does not come into contact with the object O2 and the object O3 is calculated.

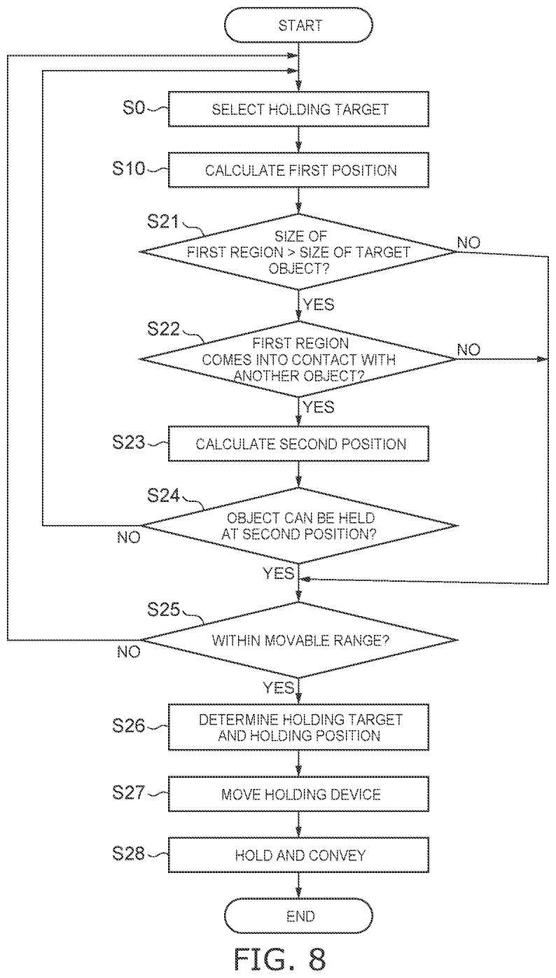

FIG. 8 is a flowchart showing an operation of the holding system according to the embodiment.

First, the control device 20 selects an object which is the holding target (step S0). Next, the control device 20 calculates the first position at which the target object is held (step S10). In step S10, the processing shown in the flowchart of FIG. 4 is executed. The control device 20 determines whether the size of the first region calculated in step S10 is larger than a size of the target object in the X-Y plane (step S21). Specifically, when a dimension of the first region in the X-direction is longer than a dimension of the target object in the X-direction, or when a dimension of the first region in the Y-direction is longer than a dimension of the target object in the Y-direction, it is determined that the size of the first region is larger than the size of the target object.

In the case where it is determined in step S21 that the size of the first region is larger than the size of the object (YES), the control device 20 determines whether the first region can come into contact with another object other than the target object (step S22). If it is determined that the first region comes into contact with the other object (YES), the control device 20 calculates the second position at which the holding device 10 comes into contact with the target object and does not come into contact with the other object (step S23). The control device 20 determines whether the holding device 10 can hold the object at the calculated second position (step S24). If it is determined that the holding device 10 cannot hold the object (NO), the control device 20 executes step S0 in order to select the holding target again. At this time, an object different from the object selected so far is selected.

If it is determined in step S21 that the size of the first region is smaller than the size of the target object (NO), if it is determined in step S22 that the first region does not come into contact with the other object (NO), or if it is determined in step S24 that the holding device 10 can hold the object (YES), the control device 20 determines whether the position of the holding device 10 is within an movable range (step S25). That is, if “NO” is determined in step S21 or “NO” is determined in step S22, it is determined whether the first position is within the movable range. If “YES” is determined in step S24, it is determined whether the second position is within the movable range.

In the case where the position of the holding device 10 is within the movable range, the holding target and a holding position are determined (step S26). That is, the object selected in the immediately preceding step S0 is determined as the holding target. The first position or the second position that is determined to be within the movable range is determined as the position of the holding device 10 for holding the target object. The control device 20 moves the holding device 10 to the determined position in order to hold the object (step S27). After causing the holding device 10 to hold the object, the control device 20 conveys the object by moving the holding device 10 (step S28).

A speed at which the object is conveyed may be controlled according to the position at which the object is held. For example, a conveying speed when the object is held at the second position is lower than the conveying speed when the object is held at the first position. Stability when the object is held at the second position is inferior to stability when the object is held at the first position. In a case where the object is held at the second position, if the object is conveyed at the same speed as when the object is held at the first position, the object may fall during conveying. By reducing the conveying speed when the object is held at the second position, it is possible to prevent the object being conveyed from falling and to more safely convey the object.

Advantages of the embodiment will be described.

It is desired that the holding device 10 can hold objects of various sizes. The smaller the holding device 10 is, the smaller a region in which the holding device 10 comes into contact with the object is. Accordingly, the holding device 10 easily comes into contact with only the target object. However, In a case where the holding device 10 is small, a force with which the holding device 10 holds an object decreases, and a heavy object may not be able to be held. There is also a possibility that a large force is locally applied to a part of the object and the object is damaged.

On the other hand, as the holding device 10 is larger, the holding force of the holding device 10 increases. The holding device 10 can hold a heavier object. When the object is held, the force applied to the object is dispersed, and thus the possibility that the object is damaged can be reduced. However, as the holding device 10 is larger, the holding device 10 more easily comes into contact with the other object other than the target object. Therefore, it is desired that an appropriate size of the holding device 10 is designed based on the size of the object that can be held by the holding device 10.

In the case where the holding device 10 designed to hold various objects holds a small object, as shown in FIG. 6A, the holding device 10 can come into contact with the other object in addition to the object serving as the holding target. Accordingly, the other object can be unintentionally held and conveyed. At this time, the other object may fall or a large force may be locally applied to the other object. As a result, the other object may be damaged.

Regarding the problem, the control device 20 according to the embodiment determines whether the holding device 10 can come into contact with the other object when the holding device 10 is present at the first position. In the case where the holding device 10 can come into contact with the other object, the control device 20 calculates the second position at which the holding device 10 comes into contact with the target object and does not come into contact with the other object. By calculating the second position, it is possible to cause the holding device 10 to hold only the target object. According to the embodiment, only the object serving as the holding target can be selectively held by the holding device 10.

Favorably, the control device 20 determines whether the holding device 10 can come into contact with the other object using the measurement error. By using the measurement error, a possibility that the holding device 10 comes into contact with an object other than the target can be further reduced.

The control device 20 favorably determines whether the holding device 10 can hold the target object at the second position. As the position of the holding device 10 moves from the first position, the force with which the holding device 10 holds the object may be reduced. Alternatively, when the object is lifted, the moment applied to the holding device 10 may increase. Accordingly, holding stability can be reduced. If it is determined that the holding device 10 cannot safely hold the target object at the second position, the control device 20 does not cause the holding device 10 to hold the object. If it is determined that the holding device 10 can hold the target object, the control device 20 causes the holding device 10 to hold the object. Accordingly, by holding the object at the second position, the possibility that the target object falls or is damaged can be reduced.

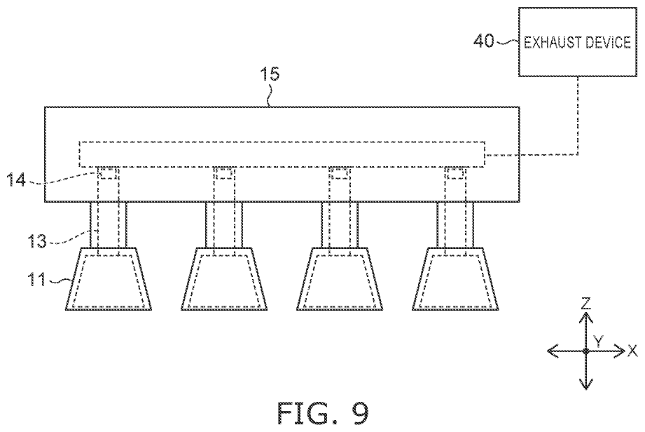

FIG. 9 is a schematic side view showing the holding device according to the embodiment.

As shown in FIG. 9, the holding device 10 includes the multiple suction pads 11, multiple flow paths 13 (pipes), multiple throttle joints 14, and a housing 15. The multiple suction pads 11 are attached to the housing 15. The housing 15 is fixed to the arm 10a (not shown in FIG. 9). The multiple flow paths 13 are respectively connected to the inside of the multiple suction pads 11. The multiple suction pads 11 are connected to an internal space of the housing 15 via the multiple flow paths 13. The internal space of the housing 15 is connected to the exhaust device 40. When the exhaust device 40 operates, the inside of the suction pads 11 is exhausted through the internal space of the housing 15. When the pressure inside the suction pad 11 is less than the atmospheric pressure, the suction force is generated. The exhaust device 40 can collectively exhaust the inside of the multiple suction pads 11.

The multiple throttle joints 14 are respectively provided in the multiple flow paths 13. Each of the throttle joints 14 includes a valve that is opened and closed according to pressure of the flow path 13. As the pressure of the flow path 13 decreases, the valve is opened and a maximum flow rate in the flow path 13 increases. When the flow path 13 is exhausted in a state in which the suction pad 11 comes into contact with the object, the pressure of the flow path 13 decreases. The valve of the flow path 13 is opened to promote exhaust of the inside of the suction pad 11. When the flow path 13 is exhausted in a state in which the suction pad 11 does not come into contact with the object, outside air is suctioned from the suction pad 11. Therefore, the pressure of the flow path 13 is less likely to change. The valve of the throttle joint 14 is closed, and the suction of the outside air through the suction pad 11 is prevented.

When the holding device 10 holds the object, if air continues to flow in from the suction pad 11 that is not in contact with the object, the inside of the suction pad 11 that comes into contact with the object is less likely to be exhausted. By providing the throttle joint 14, air leakage through the suction pad 11 that does not come into contact with the object can be reduced. Accordingly, the holding force of the holding device 10 can be increased.

As a method for reducing the leakage caused by the suction pad 11 that is not in contact with the object, there is a method of individually controlling a flow rate of air in each flow path 13. However, in this case, a configuration of the holding device 10 is more complicated, and the size of the holding device 10 is increased. When the holding device 10 holds the object, the holding device 10 is likely to interfere with the other object, and usability of the holding device 10 is reduced. By providing the respective throttle joints 14 in the respective flow paths 13, it is possible to prevent the leakage when the object is held while reducing an increase in a size of the holding device 10.

On the other hand, when the leakage is prevented by providing the throttle joints 14, the flow rate of air in each flow path 13 cannot be individually controlled. As a result, as described above, when the holding device 10 comes into contact with the other object other than the target object, the other object can also be held. However, according to the embodiment, even when the throttle joint 14 is used, it is possible to cause the holding device 10 to hold only the target object. By applying the embodiment according to the invention to the holding device 10 provided with the throttle joint 14, it is possible to cause the holding device 10 to selectively hold only the target object while reducing the increase in the size of the holding device 10.

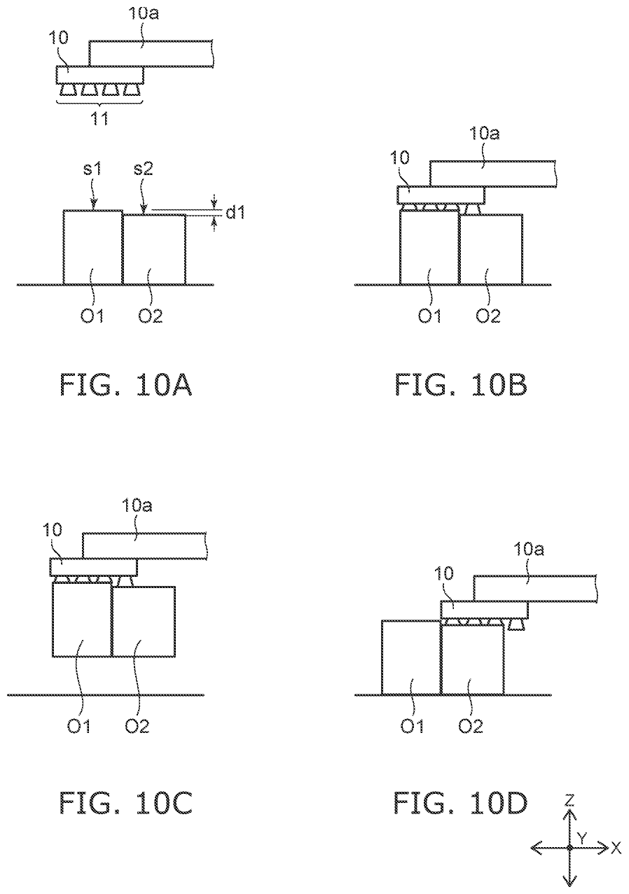

FIGS. 10A to 10D, 11A to 11C, and 12A to 12D are schematic views showing an operation of the holding system according to the embodiment.

When performing the contact determination, the control device 20 may refer to a distance in the Z-direction between an upper surface (first surface) of the target object and an upper surface (second surface) of the other object. In this case, in order to obtain a position of the upper surface of each object, depth information is acquired by the first measuring instrument 51. Alternatively, another measuring instrument for measuring a height of the upper surface of each object may be used.

In an example shown in FIG. 10A, an upper surface s2 of the object O2 is located below an upper surface s1 of the object O1. A distance d1 is a distance in the Z-direction between a position of the upper surface s1 in the Z-direction and a position of the upper surface s2 in the Z-direction. The suction pad 11 is favorably flexible such that the object can be more stably held. For example, the holding device 10 descends toward the object O1, and the suction pad 11 comes into contact with a surface of the object O1. Thereafter, as shown in FIG. 10B, the holding device 10 is further pressed toward the object O1. The suction pad 11 is deformed along a shape of the upper surface s1, and a contact area between the suction pads 11 and the upper surface s1 increases. Accordingly, the holding force for the object O1 caused by the holding device 10 can be further increased.

In a case where the distance d1 is small, when the holding device 10 is pressed toward the object O1, as shown in FIG. 10B, some of the suction pads 11 come into contact with the object O2. As a result, as shown in FIG. 10C, the object O2 may also be unintentionally held.

The control device 20 calculates the distance d1 in the contact determination to prevent the objects having different heights from being unintentionally held. The control device 20 compares the distance d1 with a predetermined threshold. In the case where the distance d1 is smaller than the threshold, the target object O1 and the adjacent object O2 may be held. The control device 20 determines that the holding device 10 can come into contact with the object O2 in addition to the object O1. Therefore, the control device 20 searches for the second position at which the holding device 10 does not contact the object O2 and holds only the object O1.

As an example, as a result of searching for the second position, it is determined that the second position capable of holding the object O1 is not obtained. As a result, the object O2 is determined to be the holding target. As shown in FIG. 10D, the object O2 is held by the holding device 10.

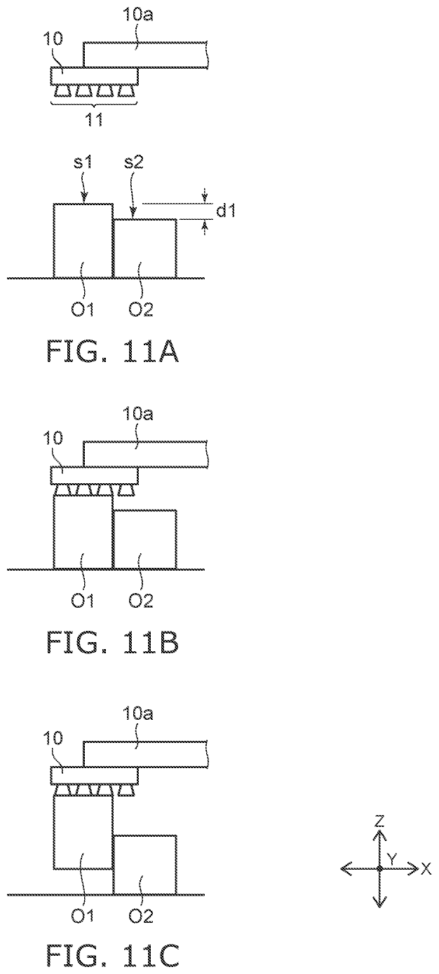

As shown in FIG. 11A, when the distance d1 is equal to or greater than the threshold, the upper surface s1 of the object O1 and the upper surface s2 of the object O2 are sufficiently separated in the Z-direction. In the contact determination, the control device 20 determines that the holding device 10 does not come into contact with the object O2. As shown in FIGS. 11B and 11C, the control device 20 causes the holding device 10 to hold the object O1.

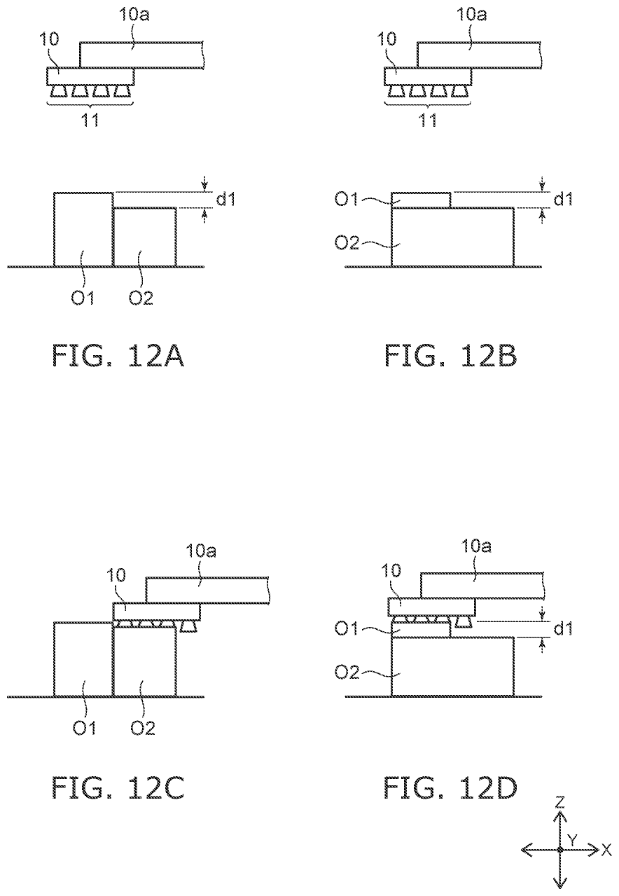

For example, a minimum dimension among dimensions in the Z-direction of objects that can be held by the holding system 1 is used as the threshold to be compared with the distance d1. In a case where a position of the upper surface s1 of the object O1 is different from a position of the upper surface s2 of the object O2, there may be both an arrangement in which the object O1 and the object O2 are arranged in the X-direction as shown in FIG. 12A and an arrangement in which the object O1 is placed on the object O2 as shown in FIG. 12B. It is difficult to distinguish the arrangements from a measurement result obtained by the first measuring instrument 51. In a case where the object O1 is placed on the object O2, when the object O2 is held and conveyed, the object O1 is also conveyed. The object O1 is not held, and thus may fall during conveying.

The distance d1 being less than the threshold (minimum dimension) indicates that the arrangements of the object O1 and the object O2 are not in a state of FIG. 12B but in a state of FIG. 12A. When the position at which the object O1 is held cannot be calculated, the control device 20 causes the holding device 10 to hold the object O2, for example, as shown in FIG. 12C. Accordingly, it is possible to stably hold only the object O2. The distance d1 being equal to or greater than the threshold indicates that the arrangements of the objects O1 and O2 may be in either the state of FIG. 12A or the state of FIG. 12B. In this case, as shown in FIG. 12D, the control device 20 holds the object O1 having a highest upper surface. Since the distance d1 is equal to or greater than the threshold, the object O2 is not held when the object O1 is held. Even when the object O1 and the object O2 are arranged in any state shown in FIGS. 12A and 12B, it is possible to stably hold only the object O1.

### First Variation

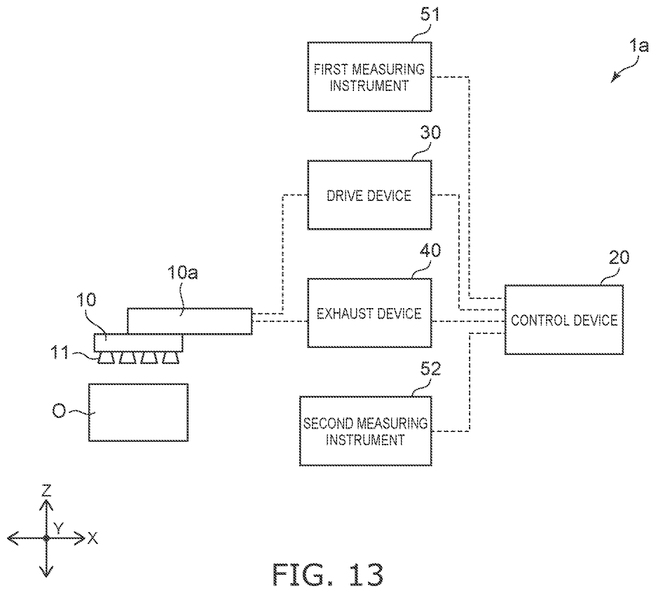

FIG. 13 is a schematic view showing a configuration of a holding system according to a first variation of the embodiment.

A holding system 1a according to the first variation further includes a second measuring instrument 52 as compared with the holding system 1. A configuration of the holding device 10 and functions of the drive device 30, the exhaust device 40, the first measuring instrument 51, and the like other than the second measuring instrument 52 are the similar to those of the holding system 1.

The second measuring instrument 52 measures the object O from a direction intersecting a Z-direction. The direction in which the second measuring instrument 52 measures may be parallel to the X-direction or the Y-direction, or may be inclined with respect to the X-direction and the Y-direction. For example, a measurement direction of the first measuring instrument 51 is parallel to a vertical direction, and a measurement direction of the second measuring instrument 52 is parallel to a horizontal plane. The second measuring instrument 52 acquires a position of an object on an X-Y plane and a size of the object on a second plane intersecting the measurement direction. The second measuring instrument 52 transmits a second measurement result including the position and size of the object to the control device 20.

For example, the second measuring instrument 52 includes a distance measuring sensor and a processing device that processes a detection result obtained by a distance measuring sensor. The processing device generates a distance image from acquired distance information and calculates the position and size of the object. The control device 20 may function as the processing device. The second measuring instrument 52 may include a camera and the processing device. In this case, the position and size of the object are calculated from an image including depth information.

Favorably, the second measuring instrument 52 includes an LRF. A measurement result using the LRF has higher accuracy than a measurement result using the camera. By using the LRF, the position of the object on the X-Y plane, a dimension (height) of the object in the Z-direction, a position of an upper surface of each object, and the like can be obtained with higher accuracy.

By using the second measuring instrument 52 in addition to the first measuring instrument 51, a measurement error of the position and size of the object on the X-Y plane can be further reduced. When the measurement error is reduced, the first region R shown in FIG. 5A is smaller. As a result, it is difficult to determine that the first region R can come into contact with another object. A possibility that a selected target is held increases, and the efficiency of holding and conveying by the holding system 1 can be increased.

### Examples

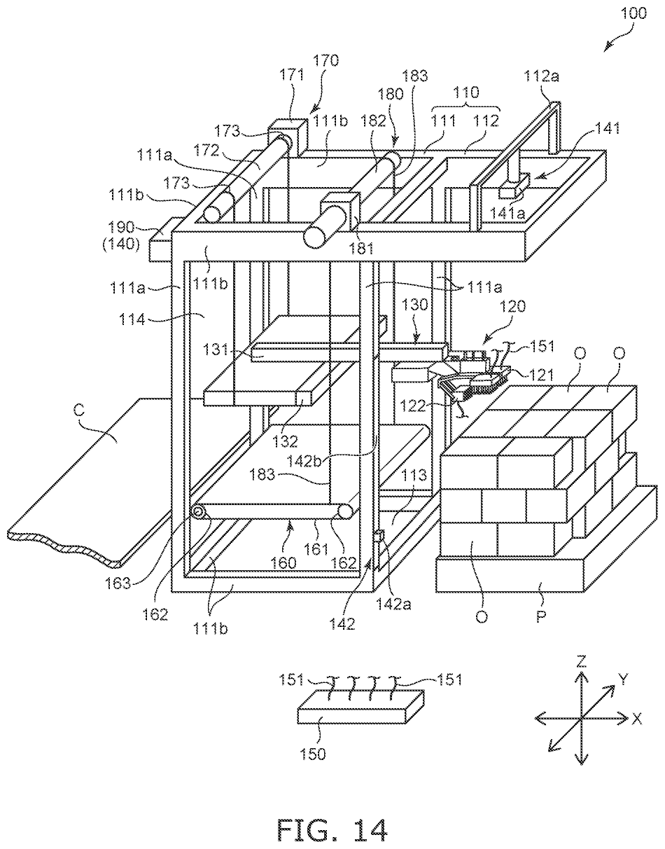

FIG. 14 is a perspective view schematically showing a cargo handling device according to an example.

The holding system 1 shown in FIG. 1 or the holding system 1a shown in FIG. 13 is implemented as a cargo handling device 100 shown in FIG. 14. The cargo handling device 100 is provided at a site at which cargo handling work of the object O is performed. For example, the cargo handling work includes unloading and loading. As an example, a conveying device C that conveys the object O is provided adjacent to the cargo handling device 100. The conveying device C is a belt conveyor, a roller conveyor, or a chain conveyor. A pallet P on which the object O is loaded is placed adjacent to the cargo handling device 100. The cargo handling device 100 is located between the conveying device C and the pallet P. The cargo handling device 100 moves the object O placed on the pallet P to the conveying device C.

As shown in FIG. 14, the cargo handling device 100 includes a support frame 110, a hand 120, a robot arm 130, a measuring device 140, a negative pressure generating device 150, a conveying device 160, a moving device 170, a moving device 180, and a control device 190. The hand 120 is an example of the holding device 10. The negative pressure generating device 150 is an example of the exhaust device 40. The moving device 170 is an example of the drive device 30. The control device 190 functions as the control device 20.

The support frame 110 supports each component of the cargo handling device 100. The hand 120 can hold the object O. The robot arm 130 moves the hand 120 along the X-Y plane. The measuring device 140 recognizes the object O and measures a position and a size of the object O. The conveying device 160 conveys the object O conveyed by the hand 120 and the robot arm 130 toward the conveying device C. The moving device 170 moves the robot arm 130 in the Z-direction. The moving device 180 moves the conveying device 160 in the Z-direction. The control device 190 controls an operation of each component of the cargo handling device 100.

Hereinafter, a specific example of each component will be described in detail.

The support frame 110 constitutes an outline of the cargo handling device 100 and is fixed to a floor surface. The support frame 110 includes a main body portion 111 and a protruding portion 112. A shape of the main body portion 111 is a rectangular parallelepiped shape. The conveying device 160 is provided inside the main body portion 111. The main body portion 111 has an opening 113 facing a pallet P side and an opening 114 facing a conveying device C side. The object O is conveyed from the pallet P to the conveying device 160 through the opening 113. The object O is conveyed from the conveying device 160 to the conveying device C through the opening 114.

The main body portion 111 includes, for example, four vertical frames 111a, and multiple horizontal frames 111b that connect upper ends and lower ends of the four vertical frames 111a. The protruding portion 112 is attached to the front of an upper portion of the main body portion 111 and protrudes forward. The protruding portion 112 is located above the pallet P.

The hand 120 holds (stably grips) the object O by suction or jamming. In a shown example, the hand 120 includes an upper surface suction unit 121 (first suction unit) and a side surface suction unit 122 (second suction unit) to suction the object O.

The robot arm 130 is an orthogonal robot. The robot arm 130 includes a first rectilinear unit 131 and a second rectilinear unit 132. The first rectilinear unit 131 is connected to the hand 120 and is extendable or slidable along the X-direction. The hand 120 can be moved along the X-direction by an operation of the first rectilinear unit 131. The second rectilinear unit 132 extends along the Y-direction and movably supports the first rectilinear unit 131 from below. The second rectilinear unit 132 moves the first rectilinear unit 131 along the Y-direction. The hand 120 can be moved along the Y-direction by an operation of the second rectilinear unit 132. The first rectilinear unit 131 and the second rectilinear unit 132 are each operated by an actuator such as a motor or an air cylinder.

The robot arm 130 is not limited to the shown example, and may be a vertical articulated robot, a horizontal articulated robot, a linear motion robot, or a parallel link robot. The robot arm 130 may include a combination of two or more selected from the vertical articulated robot, the horizontal articulated robot, the linear motion robot, an orthogonal robot, and the parallel link robot.

The measuring device 140 includes a first measuring instrument 141 and a second measuring instrument 142. The first measuring instrument 141 measures the object O placed on the pallet P from the Z-direction. The second measuring instrument 142 measures the object O from the direction intersecting the Z-direction.

Specifically, the first measuring instrument 141 includes an imaging unit 141a. The imaging unit 141a is fixed to a supporting portion 112a provided on the protruding portion 112. The imaging unit 141a includes one or two selected from an image sensor and the distance measuring sensor. The imaging unit 141a images the object O placed on the pallet P from above. The imaging unit 141a transmits an acquired image (still image) to the control device 190. The imaging unit 141a may acquire a moving image. In this case, a still image is extracted from the moving image.

The control device 190 calculates data related to the object O from the image acquired by the imaging unit 141a. The calculated data includes a recognition result of an upper surface of the object O shown in the image, positions of the upper surface in each of the X-direction, the Y-direction, and the Z-direction, a length of the upper surface in the X-direction, a length of the upper surface in the Y-direction, an area of the upper surface, and the like. The imaging unit 141a and the control device 190 function as the first measuring instrument 141. An image recognition system different from the control device 190 may be incorporated in the imaging unit 141a and used as the first measuring instrument 141.

The second measuring instrument 142 includes a distance measuring sensor 142a. The distance measuring sensor 142a measures a distance to the object O in the direction intersecting the Z-direction. In the shown example, the second measuring instrument 142 is provided on one of the multiple vertical frames 111a, and measures a distance to the object O from a direction perpendicular to the Z-direction and inclined from the X-direction and the Y-direction. The distance measuring sensor 142a emits an infrared ray, a laser beam, or an ultrasonic wave toward the object O. From a viewpoint of distance measuring accuracy, the distance measuring sensor 142a is favorably a laser range finder (LRF) using laser light. The control device 190 calculates a recognition result of a side surface of the object O, a position of the side surface of the object O on the X-Y plane, and the like based on the measurement result obtained by the distance measuring sensor 142a. The distance measuring sensor 142a and the control device 190 function as the second measuring instrument 142.

The second measuring instrument 142 may include a moving device 142b. The moving device 142b moves the distance measuring sensor 142a along the Z-direction. In this case, the control device 190 can measure the position of the upper surface of each object O in the Z-direction, the position of the lower surface of each object O in the Z-direction, the height (dimension in the Z-direction) of each object O, and the like from the measurement result obtained by the distance measuring sensor 142a and a movement amount obtained by the moving device 142b.

Similarly to the first measuring instrument 141, the second measuring instrument 142 may include an imaging unit. The imaging unit images the object O placed on the pallet P from a side. The imaging unit transmits an acquired image to the control device 190. The control device 190 calculates the recognition result of the side surface of the object O, the position of the side surface of the object O on the X-Y plane, the height of the object O, and the like from the image. In this case, the imaging unit and the control device 190 function as the second measuring instrument 142.

The negative pressure generating device 150 can individually adjust pressure of the upper surface suction unit 121 and pressure of the side surface suction unit 122. The negative pressure generating device 150 includes multiple pipes 151 respectively connected to the upper surface suction unit 121 and the side surface suction unit 122. In addition, the negative pressure generating device 150 includes a vacuum pump, an ejector, a valve, and the like (not shown).

The conveying device 160 is, for example, a belt conveyor. The conveying device 160 includes a belt 161, pulleys 162, and a drive unit 163. The belt 161 is an endless belt wound around the pair of pulleys 162 separated from each other in the X-direction. One end of the belt 161 is adjacent to the conveying device C. A rotation axis of each of the pulleys 162 is parallel to the Y-direction. The drive unit 163 drives the belt 161 by rotating one of the pair of pulleys 162. By driving the belt 161, the object O placed on the conveying device 160 is conveyed toward the conveying device C. The conveying device 160 may be a roller conveyor, a chain conveyor, or the like other than the shown example.

The moving device 170 moves the robot arm 130 along the Z-direction. The moving device 170 includes a drive unit 171, a shaft 172, and a wire 173. The drive unit 171 is attached to an upper end of the main body portion 111. The shaft 172 extends along the Y-direction and is connected to the drive unit 171. The wire 173 is wound around the shaft 172. One end of the wire 173 is connected to the robot arm 130. The drive unit 171 rotates the shaft 172. When the wire 173 is wound or expanded according to the rotation of the shaft 172, the robot arm 130 moves along the Z-direction.

Here, an example in which the moving device 170 is provided separately from the robot arm 130 is described. The moving device 170 may be provided in the robot arm 130 as an shaft for providing a degree of freedom in the Z-direction.

The moving device 180 includes a drive unit 181, a shaft 182, and a wire 183. The drive unit 181 is attached to the upper end of the main body portion 111. The shaft 182 extends along the Y-direction and is connected to the drive unit 181. The wire 183 is wound around the shaft 182. One end of the wire 183 is connected to the conveying device 160. The drive unit 181 rotates the shaft 182. When the wire 183 is wound or expanded according to the rotation of the shaft 182, the conveying device 160 moves along the Z-direction.

The control device 190 is electrically connected to the hand 120, the imaging unit 141a, the distance measuring sensor 142a, the negative pressure generating device 150, the drive unit 163, the drive unit 171, and the drive unit 181. The control device 190 controls the hand 120, the negative pressure generating device 150, the drive unit 163, the drive unit 171, the drive unit 181, and the like based on the first measurement result obtained by the first measuring instrument 141 and the second measurement result obtained by the second measuring instrument 142.

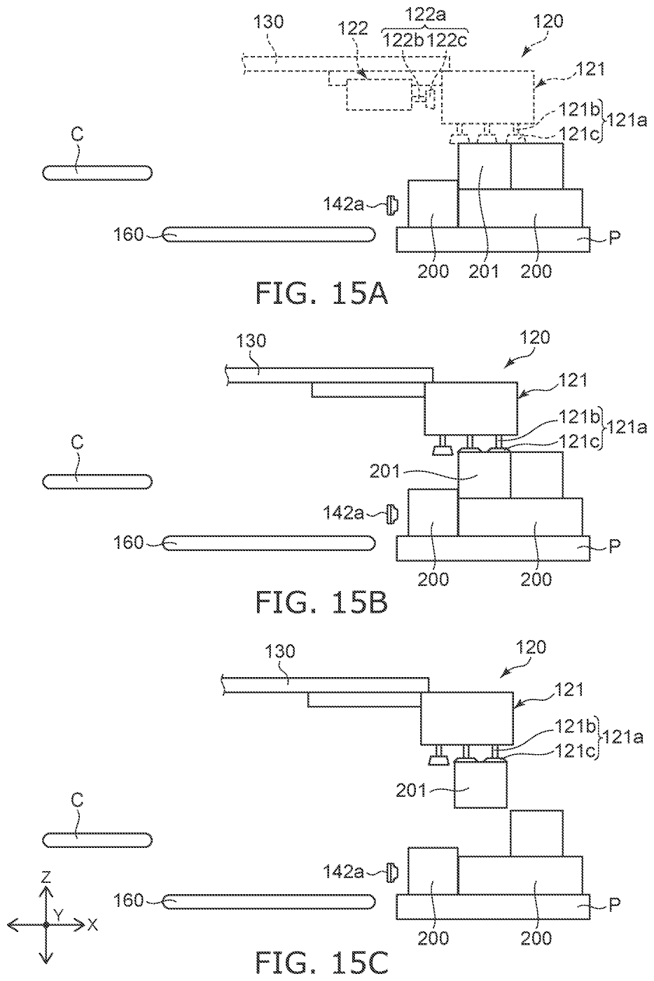

FIGS. 15A to 15C, 16A, 16B, 17A, and 17B are schematic views showing an operation of the cargo handling device according to the embodiment. Here, an example in which the hand 120 holds an object using only the upper surface suction unit 121 will be described. In FIG. 15B and thereafter, the side surface suction unit 122 is omitted.

In an example shown in FIG. 15A, multiple objects 200 are placed on the pallet P. The upper surface suction unit 121 includes a housing 121a, a rod 121b extending in the Z-direction, and a suction pad 121c provided at a tip of the rod 121b. The suction pad 121c is flexible to be deformable along an upper surface of each of the objects 200. Similarly, the side surface suction unit 122 includes a housing 122a, a rod 122b extending in the X-direction, and a suction pad 122c provided at a tip of the rod 122b. The suction pad 122c is flexible to be deformable along a side surface of the object 200.

The control device 190 selects an object 200 whose upper surface is at a highest position among the multiple objects 200 as a holding target. When there are multiple objects 200 whose upper surface are each at the highest position, the object 200 closest to the distance measuring sensor 142a is selected as the holding target. In the shown example, an object 201 that is one of the multiple objects 200 is selected as the holding target.

First, the control device 190 calculates a first position at which the hand 120 holds the object 201. A position of the hand 120 shown by a broken line in FIG. 15A is an example of the first position. When the hand 120 is present at the first position, the hand 120 comes into contact with an adjacent object 200 in addition to the object 201. Therefore, the control device 190 calculates a second position at which the hand 120 does not come into contact with the adjacent object 200.

In the case where the second position is calculated, the robot arm 130 moves the hand 120 to above the object 201 that is determined as the holding target. The side surface suction unit 122 is located behind the upper surface suction unit 121. As shown in FIG. 15B, the moving device 170 shown in FIG. 14 lowers the hand 120 toward the object 201. A position of the hand 120 shown in FIG. 15B is an example of the second position.

When the suction pad 121c comes into contact with an upper surface of the object 201, the inside of the suction pad 121c is exhausted. The upper surface suction unit 121 suctions and holds the upper surface of the object 201. As shown in FIG. 15C, in a state in which the upper surface suction unit 121 holds the object 201, the moving device 170 raises the hand 120 and the robot arm 130. Accordingly, the object 201 rises.

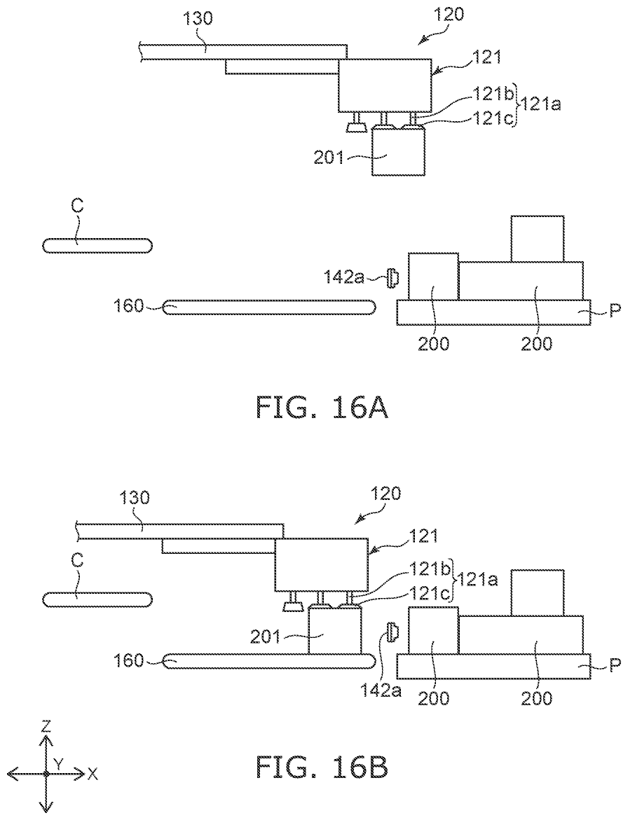

As shown in FIG. 16A, the robot arm 130 moves the hand 120 toward a space above the conveying device 160. As shown in FIG. 16B, the moving device 170 lowers the hand 120 toward the conveying device 160. Accordingly, the held object 201 is placed on the conveying device 160.

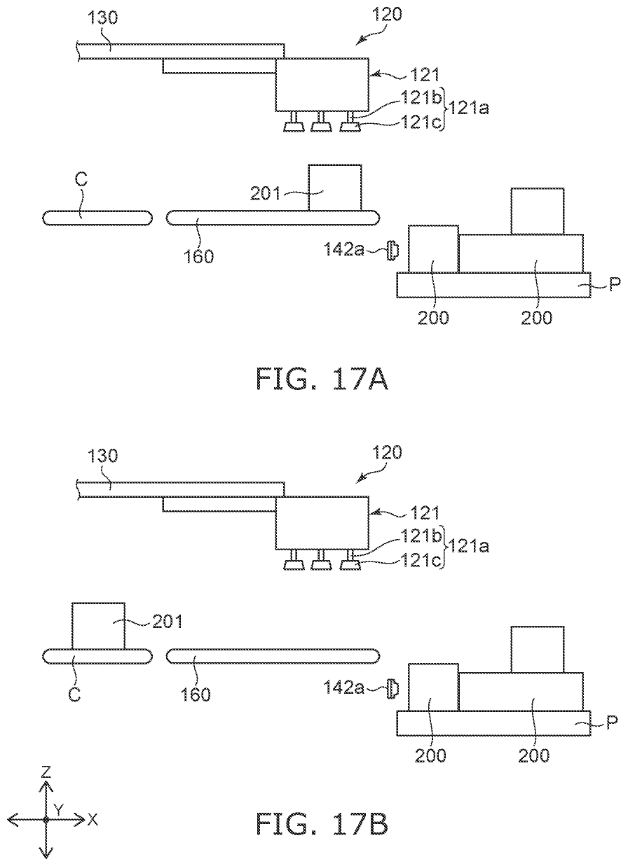

By increasing pressure inside the suction pad 121c, suction to the object 201 caused by the hand 120 is released. As shown in FIG. 17A, the moving device 170 raises the hand 120 and the robot arm 130. After the hand 120 and the robot arm 130 are raised, the moving device 180 shown in FIG. 1 raises the conveying device 160 as shown in FIG. 17A. A position of the conveying device 160 in the Z-direction is set to the same position as that of the conveying device C. As shown in FIG. 17B, the conveying device 160 conveys the conveyed object 201 to the conveying device C. The conveying device 160 may be raised during conveying the object 201.

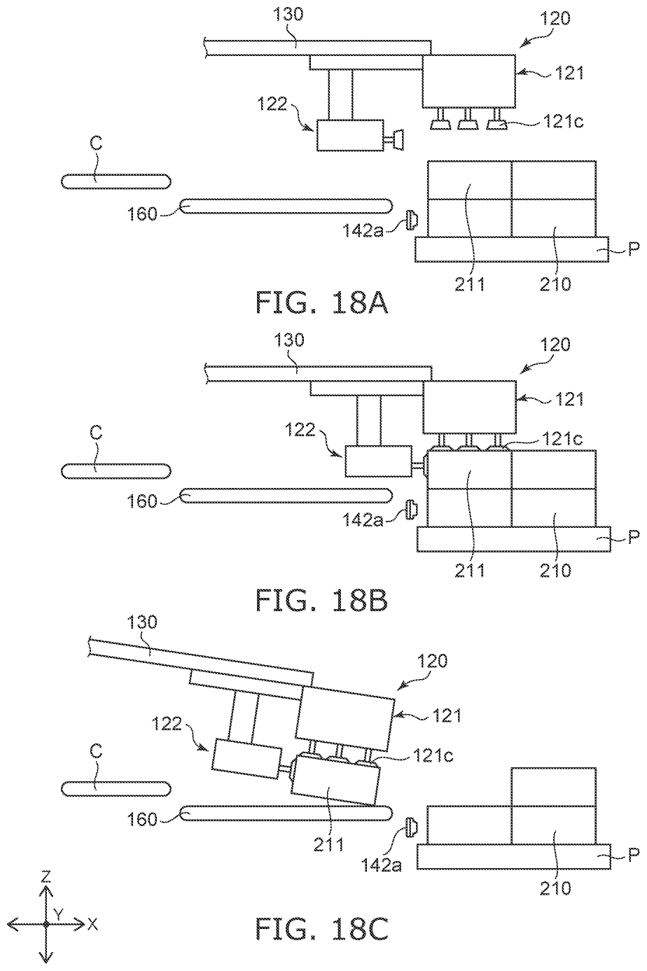

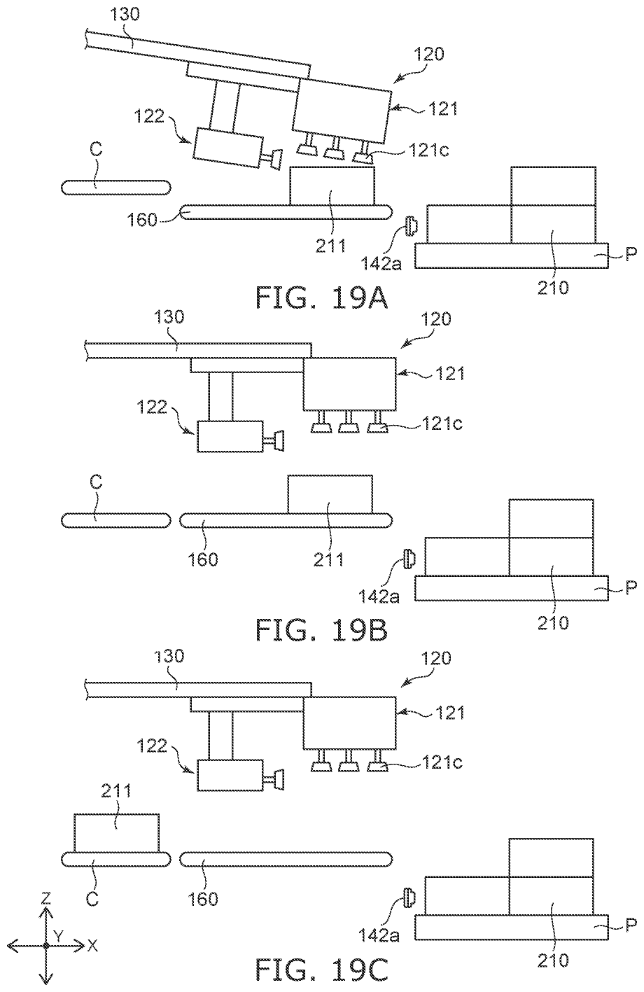

FIGS. 18A to 18C and FIGS. 19A to 19C are schematic views showing another operation performed by the cargo handling device according to the embodiment.

When the hand 120 holds the object, the side surface suction unit 122 may be used in addition to the upper surface suction unit 121. In an example shown in FIG. 18A, multiple objects 210 are placed on the pallet P. The control device 190 selects, from the multiple objects 210, an object 211 whose upper surface is at a highest position and which is closest to the distance measuring sensor 142a (or the conveying device 160) as a holding target.

After the selection, the control device 190 calculates a first position at which the object 211 is held. The control device 190 determines whether the hand 120 can come into contact with another object other than the object 211 at the first position. When the hand 120 contacts only the object 211, as shown in FIG. 18A, the robot arm 130 moves the hand 120 to a space above the object 211. The moving device 180 sets the position of the conveying device 160 in the Z-direction to the same position as a bottom surface of the object 211.

The moving device 170 lowers the hand 120 toward the object 211. As shown in FIG. 18B, the upper surface suction unit 121 and the side surface suction unit 122 come into contact with an upper surface and a side surface of the object 211, respectively. The inside of the suction pad 121c and inside of the suction pad 122c are exhausted, and the object 211 is suctioned by the upper surface suction unit 121 and the side surface suction unit 122.

As shown in FIG. 18C, the robot arm 130 conveys the object 211 onto the conveying device 160. For example, the object 211 is slid by the robot arm 130 and conveyed onto the conveying device 160. At this time, as shown in the figure, the hand 120 may be inclined with respect to the X-Y plane. Accordingly, a contact area between the bottom surface of the object 211 and another object 210 (or the pallet P) can be reduced, and friction can be reduced.

When the pressure inside the suction pad 121c and the pressure inside the suction pad 122c increase, as shown in FIG. 19A, the holding caused by the upper surface suction unit 121 and the side surface suction unit 122 is released. As shown in FIG. 19B, the moving device 180 sets the position of the conveying device 160 in the Z-direction to the same position as the conveying device C. The moving device 170 raises the hand 120 and the robot arm 130. As shown in FIG. 19C, the conveying device 160 conveys the conveyed object 211 to the conveying device C.

In the operations described above, the operations of the robot arm 130, the conveying device 160, the moving device 170, and the moving device 180 are controlled by the control device 190.

By using both the upper surface suction unit 121 and the side surface suction unit 122, holding stability is improved as compared with a case where only the upper surface suction unit 121 is used. In a case of sliding an object, the time required for conveyance can be reduced compared to a case of raising the object. Therefore, the efficiency of the cargo handling work can be improved. On the other hand, in the case where only the upper surface suction unit 121 is used, since the object is raised and conveyed, the object can be conveyed regardless of a state between the held object and the conveying device 160.

Whether to use the holding caused by the side surface suction unit 122 may be determined according to an arrangement of the objects 210. In the example shown in FIG. 14A, the multiple objects having different sizes are arranged. In this case, the objects are held only by the upper surface suction unit 121 without using the side surface suction unit 122. In the example shown in FIG. 17A, the multiple objects having the same size are arranged. In this case, the objects are held by the upper surface suction unit 121 and the side surface suction unit 122. In the arrangement shown in FIG. 17A, in each stage, upper surfaces of the objects are arranged in the X-direction and the Y-direction. Therefore, when an object located away from the conveying device 160 is conveyed, the object can slide on an upper surface of another object.

An instruction as to whether to use the side surface suction unit 122 may be input to the cargo handling device 100. The cargo handling device 100 switches whether to use the side surface suction unit 122 according to the received instruction. The instruction may be input by a user, or may be transmitted by an upper host computer or the like. Whether to use the side surface suction unit 122 may be determined based on the measurement results of the first measuring instrument 141 and the second measuring instrument 142. For example, when a path between the object 210 determined as the holding target and the conveying device 160 is flat and the object 210 can be slid, the side surface suction unit 122 is used. When the path is not flat, the side surface suction unit 122 is not used. The path is the upper surface of the other object 210 or the upper surface of the pallet P.

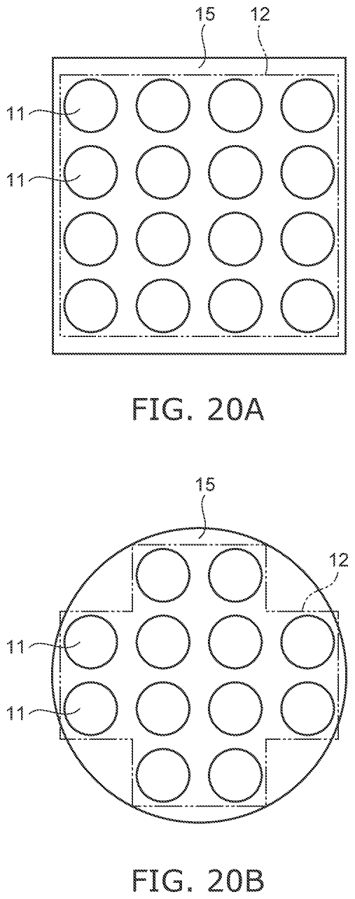

FIGS. 20A and 20B are schematic views illustrating an arrangement of the suction pads 11.

In the example described above, as shown in FIG. 20A, the number of the suction pads 11 arranged in the X-direction is the same in each portion in the Y-direction, and the number of the suction pads 11 arranged in the Y-direction is the same in each portion in the X-direction. The arrangement of the multiple suction pads 11 is not limited to the example. For example, as shown in FIG. 20B, the number of the suction pads 11 arranged in the X-direction may be different in each portion in the Y-direction, and the number of the suction pads 11 arranged in the Y-direction may be different in each portion in the X-direction. The size and shape of the holding region 12 referred to in the contact determination are appropriately set according to the arrangement of the multiple suction pads 11.

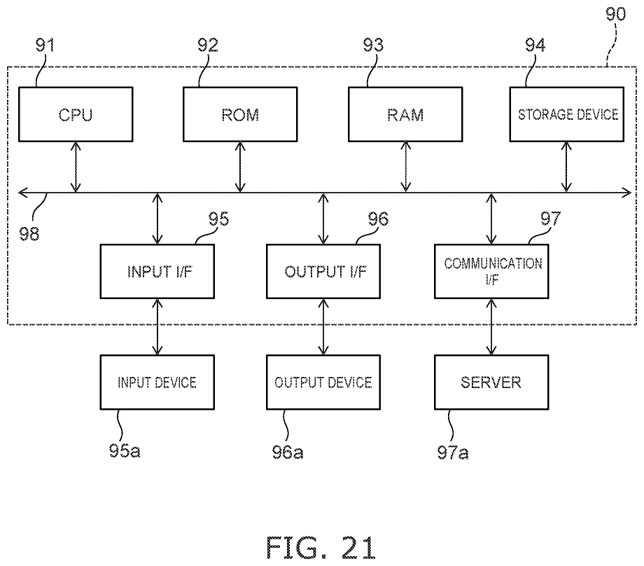

FIG. 21 is a schematic view showing a hardware configuration.

For example, a computer 90 shown in FIG. 21 is used as the control device 20 or the control device 190. The computer 90 includes a CPU 91, a ROM 92, a RAM 93, a storage device 94, an input interface 95, an output interface 96, and a communication interface 97.

The ROM 92 stores a program for controlling an operation of the computer 90. The ROM 92 stores a program necessary for causing the computer 90 to implement the processing described above. The RAM 93 functions as a storage region in which the program stored in the ROM 92 is loaded.

The CPU 91 includes a processing circuit. The CPU 91 executes a program stored in at least one of the ROM 92 and the storage device 94 using the RAM 93 as a work memory. During execution of the program, the CPU 91 controls each configuration via a system bus 98 to execute various types of processing.

The storage device 94 stores data necessary for executing the program and data obtained by executing the program.

The input interface (I/F) 95 can connect the computer 90 to an input device 95a. The input I/F 95 is, for example, a serial bus interface such as a USB. The CPU 91 can read various types of data from the input device 95a via the input I/F 95.

The output interface (I/F) 96 can connect the computer 90 to an output device 96a. The output I/F 96 is, for example, a video output interface such as a digital visual interface (DVI) or a high-definition multimedia interface (HDMI (registered trademark)). The CPU 91 can transmit data to the output device 96a via the output I/F 96 and display an image on the output device 96a.

The communication interface (I/F) 97 can connect a server 97a outside the computer 90 to the computer 90. The communication I/F 97 is, for example, a network card such as an LAN card. The CPU 91 can read various types of data from the server 97a via the communication I/F 97.

The storage device 94 includes one or more selected from a hard disk drive (HDD) and a solid state drive (SSD). The input device 95a includes one or more selected from a mouse, a keyboard, a microphone (voice input), and a touch pad. The output device 96a includes one or more selected from a monitor, a projector, a printer, and a speaker. A device having both functions of the input device 95a and the output device 96a, such as a touch panel, may be used.

Each processing executed by the control device 20 or the control device 190 may be implemented by one computer 90 or may be implemented by cooperation of multiple computers 90.

The various data processes may be recorded in a magnetic disk (a flexible disk, a hard disk, or the like), an optical disk (a CD-ROM, a CD-R, a CD-RW, a DVD-ROM, a DVD±R, a DVD±RW, or the like), a semiconductor memory, or another non-transitory computer-readable storage medium as a program that can be executed by a computer.

For example, information recorded in a recording medium can be read by a computer (or an embedded system). In the recording medium, a recording format (storage format) is any format. For example, the computer reads the program from the recording medium and causes the CPU to execute an instruction written in the program based on the program. In the computer, the program may be obtained (or read) through a network.

The embodiments may include the following features.

### Feature 1

A control device for controlling a holding device capable of holding an object,
the control device being configured to
   calculate a first position at which a first object is held by the holding device,
   determine whether the holding device is capable of coming into contact with another object when the holding device is present at the first position, and
   calculate a second position at which the holding device comes into contact with the first object and does not come into contact with the other object in a case where the holding device is capable of coming into contact with the other object.

### Feature 2

The device according to Feature 1, wherein
a first measurement result is received from a first measuring instrument configured to measure the object from the first direction,
the first measurement result includes a position and a size of the object on a first surface intersecting a first direction, and
the first position is calculated using the first measurement result.

### Feature 3

The device according to Feature 2, wherein
in the determination, it is determined whether the holding device is capable of coming into contact with the other object using the first measurement result and a measurement error on the first surface.

### Feature 4

The device according to Feature 2, wherein
a second measurement result is received from a second measuring instrument configured to measure a size of the object from a direction intersecting the first direction,
the second measurement result includes a position of the object on the first surface and a size of the object on a second surface crossing the intersecting direction is received, and
the first position is calculated using the first measurement result and the second measurement result.

### Feature 5

The device according to Feature 4, wherein
in the determination, it is determined whether the holding device is capable of coming into contact with the other object using the first measurement result, the second measurement result, and a measurement error on the first surface.

### Feature 6

The device according to Feature 3 or 5, wherein
in the determination,
   a first region is calculated by adding the measurement error to a holding region capable of holding an article in the holding device, and
   in a case where the first region is aligned with the other object in the first direction and a distance in the first direction between a first surface of the first object intersecting the first direction and a second surface of the other object intersecting the first direction is less than a predetermined threshold, it is determined that the holding device is capable of coming into contact with the other object.

### Feature 7

The device according to any one of Features 1 to 6, wherein
in a case where the holding device is capable of coming into contact with the other object, the second position is calculated by changing a position of the holding device from the first position from a contact region between the holding device and the other object toward a contact region between the holding device and the first object.

### Feature 8

The device according to any one of Features 1 to 7, wherein
it is determined whether the first object is capable of being held by the holding device at the second position, and
in a case where the first object is capable of being held, the holding device is caused to hold the first object.

### Feature 9

The device according to Feature 8, wherein
in a case where the holding device is not capable of holding the first object at the second position, another first position at which a second object is held by the holding device is calculated.

### Feature 10

The device according to any one of Features 1 to 9, wherein
the holding device includes a plurality of suction pads, and
at least a part of the plurality of the suction pads holds an upper surface of the first object.

### Feature 11

A holding system comprising:
the control device according to any one of Features 1 to 9; and
the holding device including a plurality of suction pads, wherein
the control device causes at least a part of the plurality of the suction pads to hold the first object at the first position or the second position.

### Feature 12

The system according to Feature 11, wherein
the control device causes the holding device to convey the held first object, and
a conveying speed when the first object is held at the second position is lower than a conveying speed when the first object is held at the first position.

### Feature 13

The system according to Feature 11, or 12 wherein
the holding device includes
   a plurality of flow paths respectively connected to the plurality of suction pads, and
   a plurality of throttle joints respectively provided in the plurality of flow paths, and configured to close the flow paths according to an air flow.

### Feature 14

A cargo handling device comprising:
the control device according to any one of Features 1 to 9;
the holding device including a plurality of suction pads; and
a conveying device on which the first object held by the holding device is placed and which conveys the placed first object.

### Feature 15

A processing method comprising:
causing a computer to
   calculate a first position at which a first object is held by a holding device;
   determine whether the holding device is capable of coming into contact with another object when the holding device is present at the first position; and
   calculate a second position at which the holding device comes into contact with the first object and does not come into contact with the other object in a case where the holding device is capable of coming into contact with the other object.

### Feature 16

A program for causing a computer to execute the processing method according to Feature 15.

### Feature 17

A non-transitory computer-readable storage medium storing a program for causing a computer to execute the processing method according to Feature 16.

While certain embodiments of the inventions have been illustrated, these embodiments have been presented by way of example only, and are not intended to limit the scope of the inventions. These novel embodiments may be embodied in a variety of other forms; and various omissions, substitutions, modifications, etc., can be made without departing from the spirit of the inventions. These embodiments and their modifications are within the scope and spirit of the inventions and are within the scope of the inventions described in the claims and their equivalents. The embodiments described above can be implemented in combination with each other.

What is claimed is:

1. A control device for controlling a holding device capable of holding an object,
the control device being configured to
calculate a first position at which a first object is held by the holding device,
determine whether the holding device is capable of coming into contact with another object when the holding device is present at the first position, and
calculate a second position at which the holding device comes into contact with the first object and does not come into contact with the other object in a case where the holding device is capable of coming into contact with the other object.

2. The device according to claim 1, wherein
a first measurement result is received from a first measuring instrument configured to measure the object from the first direction,
the first measurement result includes a position and a size of the object on a first surface intersecting a first direction, and
the first position is calculated using the first measurement result.

3. The device according to claim 2, wherein
in the determination, it is determined whether the holding device is capable of coming into contact with the other object using the first measurement result and a measurement error on the first surface.

4. The device according to claim 2, wherein
a second measurement result is received from a second measuring instrument configured to measure a size of the object from a direction intersecting the first direction,
the second measurement result includes a position of the object on the first surface and a size of the object on a second surface crossing the intersecting direction is received, and
the first position is calculated using the first measurement result and the second measurement result.

5. The device according to claim 4, wherein
in the determination, it is determined whether the holding device is capable of coming into contact with the other object using the first measurement result, the second measurement result, and a measurement error on the first surface.

6. The device according to claim 3, wherein
in the determination,
a first region is calculated by adding the measurement error to a holding region capable of holding an article in the holding device, and
in a case where the first region is aligned with the other object in the first direction and a distance in the first direction between a first surface of the first object intersecting the first direction and a second surface of the other object intersecting the first direction is less than a predetermined threshold, it is determined that the holding device is capable of coming into contact with the other object.

7. The device according to claim 1, wherein
in a case where the holding device is capable of coming into contact with the other object, the second position is calculated by changing a position of the holding device from the first position from a contact region between the holding device and the other object toward a contact region between the holding device and the first object.

8. The device according to claim 1, wherein
it is determined whether the first object is capable of being held by the holding device at the second position, and
in a case where the first object is capable of being held, the holding device is caused to hold the first object.

9. The device according to claim 8, wherein
in a case where the holding device is not capable of holding the first object at the second position, another first position at which a second object is held by the holding device is calculated.

10. The device according to claim 1, wherein
the holding device includes a plurality of suction pads, and
at least a part of the plurality of the suction pads holds an upper surface of the first object.

11. A holding system comprising:
the control device according to claim 1; and
the holding device including a plurality of suction pads, wherein
the control device causes at least a part of the plurality of the suction pads to hold the first object at the first position or the second position.

12. The system according to claim 11, wherein
the control device causes the holding device to convey the held first object, and
a conveying speed when the first object is held at the second position is lower than a conveying speed when the first object is held at the first position.

13. The system according to claim 11, wherein
the holding device includes
a plurality of flow paths respectively connected to the plurality of suction pads, and
a plurality of throttle joints respectively provided in the plurality of flow paths, and configured to close the flow paths according to an air flow.

14. A cargo handling device comprising:
the control device according to claim 1;
the holding device including a plurality of suction pads; and
a conveying device on which the first object held by the holding device is placed and which conveys the placed first object.

15. A processing method comprising:
causing a computer to
calculate a first position at which a first object is held by a holding device;
determine whether the holding device is capable of coming into contact with another object when the holding device is present at the first position; and
calculate a second position at which the holding device comes into contact with the first object and does not come into contact with the other object in a case where the holding device is capable of coming into contact with the other object.

16. A non-transitory computer-readable storage medium storing a program for causing a computer to execute the processing method according to claim 15.
